(19) United States
(12) Patent Application Publication
(10) Pub. No.: US 2018/0326263 A1
(43) Pub. Date: Nov. 15, 2018

(54) Tennis Ball Sorter Apparatus and Methods of Using the Same

(71) Applicants: Caroline Rausch, Lake in the Hills, IL (US); Christopher Rausch, Lake in the Hills, IL (US); Rutu Brahmbhatt, Crystal Lake, IL (US); Erin Cook, Lake in the Hills, IL (US)

(72) Inventors: Caroline Rausch, Lake in the Hills, IL (US); Christopher Rausch, Lake in the Hills, IL (US); Rutu Brahmbhatt, Crystal Lake, IL (US); Erin Cook, Lake in the Hills, IL (US)

(21) Appl. No.: 15/980,252

(22) Filed: May 15, 2018

Related U.S. Application Data
(60) Provisional application No. 62/506,356, filed on May 15, 2017.

(51) Int. Cl. A63B 47/00; B07C 5/34; G01L 17/00

(52) U.S. Cl. CPC A63B 47/008; A63B 47/002; A63B 2220/56; G01L 17/005; B07C 5/3404

(57) ABSTRACT

A tennis ball sorting apparatus tests the internal pressure of individual tennis balls and automatically separates a large number of tennis balls based on their internal pressure. Methods of using the same are further provided.

The present invention claims priority to U.S. Provisional Patent Application No. 62/506,356 titled “Tennis Ball Sorting Apparatus and Methods of Using the Same,” having a filing date of May 15, 2017, which is incorporated herein by reference in its entirety.

### TECHNICAL FIELD

The present invention relates to a tennis ball sorting apparatus. Specifically, the tennis ball sorting apparatus tests the internal pressure of individual tennis balls and automatically separates a large number of tennis balls based on their internal pressure. Methods of using the same are further provided.

### BACKGROUND

To play tennis, a tennis ball is hit back and forth between two or more players standing on opposite sides of a net. The tennis ball typically has a diameter between roughly 2.5 inches and 2.7 inches, and further has a felt coating on an outside thereof. The ball itself is hollow, with an internal pressure that provides a certain spring or “pop” when it is hit by a tennis racket.

Tennis balls typically are purchased in pressurized packs that maintain the internal pressure of the tennis balls until they are removed from the packs for play. However, as soon as a tennis ball is removed from its pressurized back, air can start to leak out of the tennis ball, because the internal pressure of the tennis ball is higher than atmospheric pressure. Although the leakage of air is fairly slow, as time goes on a tennis ball can become difficult to use or undesirable as it becomes “flat.”

Oftentimes, the degree of “flatness” of a tennis ball is often measured imprecisely, typically by “feel.” In other words, a user simply feels a specific tennis ball with his or her hands, pushes upon its outer skin, or bounces it, to determine whether the ball is still playable or whether it is “dead.” However, testing the flatness of tennis balls manually is often imprecise, and is very difficult to do timely if a large number of tennis balls must be tested and sorted.

It is estimated that there are about 18 million tennis players in the United States, and besides the “feel” test noted above, there is no readily available and efficient way to precisely test whether a ball is playable or dead due to depressurization of the tennis ball over time. Indeed, at racket clubs or other like facilities, hundreds of tennis balls may be utilized in practice and in matches. Oftentimes, handlers must sort these tennis balls by hand to separate the playable balls from the dead balls. This method of sorting the tennis balls is tedious and time-consuming.

A need, therefore, exists for a tennis ball sorter apparatus. Specifically, a need exists for an apparatus that separates and sorts tennis balls based on their internal pressure.

More specifically, a need exists for a tennis ball sorting apparatus and method of using the same that processes a large amount of tennis balls in a relatively short amount of time. Moreover, a need exists for a tennis ball sorting apparatus that automatically tests each tennis ball to determine its internal pressure for purposes of sorting the same based on its internal pressure.

Further, a need exists for a tennis ball sorting apparatus that separates the tennis balls based on a pre-defined internal pressure threshold into playable tennis balls and dead tennis balls. Still further, a need exists for a tennis ball sorting apparatus that determines individual tennis balls' internal pressure with a high degree of precision and efficiency.

### SUMMARY OF THE INVENTION

The present invention relates to a tennis ball sorting apparatus. Specifically, the tennis ball sorting apparatus tests the internal pressure of individual tennis balls and automatically separates a large number of tennis balls based on their internal pressure. Methods of using the same are further provided.

To this end, in an embodiment of the present invention, a ball sorting apparatus is provided. The ball sorting apparatus comprises a feeder for holding a large number of balls and feeding one or more balls to an internal pressure tester, wherein the internal pressure tester tests the internal pressure of each ball as it is fed thereinto, and further comprising a separating unit, wherein the separating unit routes the ball into two or more paths based on its internal pressure.

In an embodiment, the feeder comprises a hopper, wherein the hopper holds the large number of balls.

In an embodiment, the feeder comprises a screw, wherein the screw has a thread and pitch, wherein the thread and pitch of the screw are sized to hold the ball therein.

In an embodiment, the ball is a tennis ball.

In an embodiment, the testing unit comprises a first surface and a second surface and a gauge interconnected with the first surface, wherein when the ball is positioned between the first surface and the second surface, the gauge pushes the first surface against the ball thereby applying a pressure to the ball and further wherein the gauge measures a resistance of the ball in response to the pressure on the ball, wherein the resistance of the ball corresponds to the ball's internal pressure.

In an embodiment, the gauge takes a plurality of readings of the ball.

In an embodiment, the ball sorting apparatus further comprises: an opening on a side of the feeder aligned with the screw, wherein the ball is fed through the opening by the screw onto a ball path that leads to the testing unit.

In an embodiment, the ball path comprises a first surface and a second surface, wherein the second surface comprises a first roller having a gripping element and the ball moves along the first surface due to turning of the roller.

In an embodiment, the first roller is interconnected to the screw and turns at the same speed as the screw.

In an embodiment, wherein the separation unit comprises a reversible roller and a first path and a second path, wherein when the ball is tested by the testing unit and has a measured internal pressure below a pre-defined internal pressure, the reversible roller turns a first direction and routes the ball onto the first path, and further when the ball has a measured internal pressure above a pre-defined internal pressure, the reversible roller turns a second direction and routes the ball onto the second path.

In an embodiment, the first path leads to a first collection bin, and the second path leads to a second collection bin.

In an alternate embodiment of the present invention, a method of testing and sorting balls comprising an internal pressure is provided. The method comprises the steps of: providing a ball sorting apparatus comprising a feeder for holding a plurality of balls and feeding each of the plurality of balls to a testing unit, wherein the testing unit tests the internal pressure of each ball as each ball is fed thereinto, and a separation unit, wherein the separation unit routes each ball into one of two or more paths based on the internal pressure of each ball; and feeding a plurality of balls into the feeder, wherein the feeder feeds a first ball into the testing unit wherein the testing unit tests the internal pressure of the first ball, and further wherein the separation unit feeds the first ball into the one of two or more paths based on the internal pressure of the first ball.

In an embodiment, the feeder comprises a hopper, wherein the hopper holds the large number of balls.

In an embodiment, the feeder comprises a screw, wherein the screw has a thread and pitch, wherein the thread and pitch of the screw are sized to hold the ball therein, and further wherein the screw moves the first ball out of the feeder.

In an embodiment, the first ball is a tennis ball.

In an embodiment, the testing unit comprises a first surface and a second surface and a gauge interconnected with the first surface and further comprising the steps of: feeding the first ball between the first surface and the second surface wherein when the first ball is positioned between the first surface and the second surface, the gauge pushes the first surface against the first ball thereby applying a pressure to the first ball; and measuring, via the gauge, a resistance of the ball in response to the pressure on the ball wherein the resistance of the ball corresponds to the ball's internal pressure.

In an embodiment, the method further comprises the step of: taking a plurality of readings of the first ball via the gauge.

In an embodiment, a side of the feeder comprises an opening aligned with the screw, and further comprising the step of: feeding the first ball through the opening via the screw, onto a ball path that leads to the testing unit.

In an embodiment, the ball path comprises a first surface and a second surface, wherein the second surface comprises a first roller interconnected with the screw and having a gripping element; turning the first roller; and moving the first ball along the first surface due to turning of the roller.

In an embodiment, the separation unit comprises a reversible roller and a first path and a second path, and further comprising the step of: when, after testing the internal pressure of the first ball and the first ball has a measured internal pressure below a pre-defined internal pressure, routing the first ball onto the first path by turning the reversible roller the first direction or routing the first ball onto the second path by turning the reversible roller in a second direction.

It is, therefore, an advantage and objective of the present invention to provide a tennis ball sorter apparatus.

Specifically, it is an advantage and objective of the present invention to provide an apparatus that separates and sorts tennis balls based on their internal pressure.

More specifically, it is an advantage and objective of the present invention to provide a tennis ball sorting apparatus and method of using the same that processes a large amount of tennis balls in a relatively short amount of time.

Moreover, it is an advantage and objective of the present invention to provide a tennis ball sorting apparatus that automatically tests each tennis ball to determine its internal pressure for purposes of sorting the same based on its internal pressure.

Further, it is an advantage and objective of the present invention to provide a tennis ball sorting apparatus that separates the tennis balls based on a pre-defined internal pressure threshold into playable tennis balls and dead tennis balls.

Still further, it is an advantage and objective of the present invention to provide a tennis ball sorting apparatus that determines individual tennis balls' internal pressure with a high degree of precision and efficiency.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a tennis ball internal pressure tester and sorting apparatus in an embodiment of the present invention.

FIG. 2 illustrates a close-up side view of a tennis ball internal pressure testing module and sorting module in an embodiment of the present invention.

FIG. 3 illustrates a close-up view of a tennis ball internal pressure testing module testing the internal pressure of a tennis ball in an embodiment of the present invention.

FIGS. 4A and 4B illustrate a close-up view of a tennis ball internal pressure sorting module sorting tennis balls based on their internal pressures in an embodiment of the present invention.

FIG. 5 illustrates a side perspective view of a tennis ball sorting apparatus in an alternate embodiment of the present invention.

FIG. 6 illustrates a top view of a tennis ball hopper module of a tennis ball sorting apparatus in an alternate embodiment of the present invention.

FIG. 7 illustrates a cut-away top perspective view of a tennis ball sorting apparatus in an alternate embodiment of the present invention.

FIG. 8 illustrates a side view of a tennis ball sorting apparatus in an alternate embodiment of the present invention.

### DETAILED DESCRIPTION OF THE PRESENTLY PREFERRED EMBODIMENTS

The present invention relates to a tennis ball sorting apparatus. Specifically, the tennis ball sorting apparatus tests the internal pressure of individual tennis balls and automatically separates a large number of tennis balls based on their internal pressure. Methods of using the same are further provided.

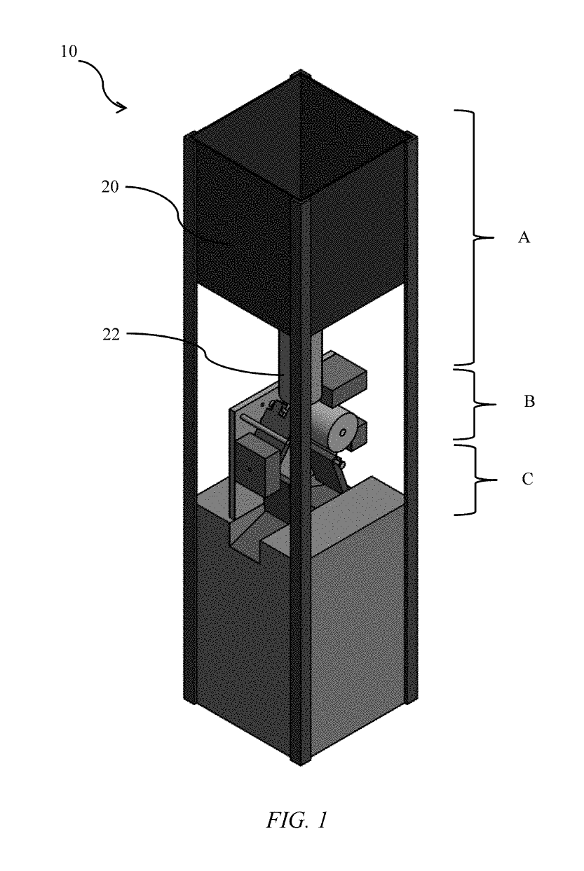

Referring now to the figures, FIG. 1 illustrates a tennis ball internal pressure testing and sorting apparatus 10 in an embodiment of the present invention. The tennis ball testing and sorting apparatus 10 comprises three main modules: a feeding module A, an internal pressure testing module B and a sorting module C. Although the present invention describes the present apparatus 10 as testing and sorting the internal pressure of tennis balls, it should be noted that the apparatus 10, described herein, may also be utilized test any ball having an internal pressure, such as racquet balls, squash balls, and other like balls having internal pressures that may lose their pressures over time and require testing and sorting thereof.

The feed module A of the present invention comprises, generally, a funnel element 20 and a feed tube 22. The funnel element 20 holds a large number of tennis balls requiring testing and sorting, and the feed tube 22 may feed individual tennis balls from the funnel element 20 into the tennis ball testing module C. Specifically, the feed tube 22 may be sized to allow only single tennis balls therethough in a serial manner.

The feed module A may further have an agitator (not shown) that agitates the tennis balls as they are held in the funnel element 20 to aid in moving the tennis balls from the funnel element 20 to the feed tube 22. The agitator may take the form of a rod, paddle or other like element that moves within the funnel to ensure that the tennis balls do not get clogged within the funnel element 20. Alternatively, the funnel element 20 may vibrate causing the tennis balls to continuously move through the funnel element 20 into the feed element 22. The agitator may be utilized to ensure that the tennis balls do not get stuck within the funnel element 20, especially since the movement of tennis balls in contact with each other is naturally limited due to their felt coatings.

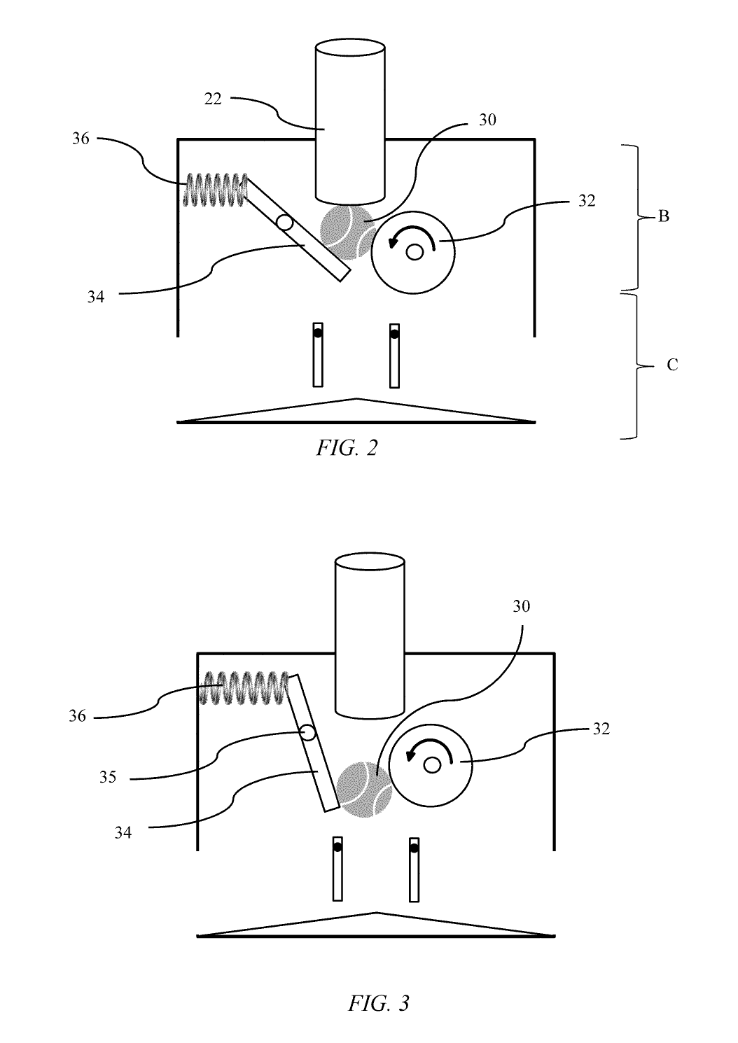

As the tennis balls are fed through the funnel element 20 into the feed tube 22, they may individually be moved, by gravity or by mechanical means, into internal pressure tester module B. FIG. 2 illustrates a close-up side view of tennis ball internal testing module B and sorting module C. A tennis ball 30 may be placed within the testing module C after being feed through feed tube 22, and may be tested to measure its internal pressure. Specifically, the tennis ball 30 may be fed into testing position on hinged testing paddle 32 and contacting wheel 34. Testing paddle 32 may have spring 36 biasing paddle 32 toward wheel 34 via axis 35. As wheel 34 spins in a counter-clockwise direction pursuant to the view of FIG. 2, it may move the tennis ball past testing paddle 32, which may deflect away from the wheel 34 as the tennis ball moves past it, as illustrated in FIG. 3. The measure of the deflection of the testing paddle 32 is directly related to the internal pressure of the tennis ball 30. Specifically, the tennis ball 30 may deflect the testing paddle more if the internal pressure of the tennis ball is relatively high, indicating that the tennis ball 30 is “fresh” or “new” and useful. Likewise, the tennis ball 30 may deflect the testing paddle less if the internal pressure of the tennis ball is relatively low, indicating that the tennis ball is “dead” or “old” and no longer useful, requiring separation from other tennis balls that are fresh, or fresher.

The degree of deflection that identifies whether a tennis ball is “fresh” or “old” may be defined by a user of the system using a control system (not shown). Specifically, the degree of deflection may be precisely measured by a potentiometer, for example, which may be based on the degree of movement of axis 38 on paddle 32. Alternatively, the degree of deflection may be measured based on the movement of the spring 36, the amount of radial travel of the testing paddle 32, or via any other method apparent to one of ordinary skill in the art, and the invention should not be limited as described herein.

The wheel 34 may be controlled via a motor and the control system that may be programmed to automatically spin and move a tennis ball therethrough at specifically defined times, in synchronization with the other elements and modules of the present invention. The wheel further may have a circumferential groove sized to hold the curve of the tennis ball 30, and may further have a material on its tennis ball contacting surface to grip the tennis ball 30 and move it past the paddle 32.

The deflection of the testing paddle 32 provides a precise measurement of the internal pressure of the tennis ball 30. If the deflection of the testing paddle 32 and, therefore, the internal pressure of the tennis ball 30 is measured above a pre-defined threshold, then the tennis ball 30 is considered to be relatively “fresh” (or at least fresh enough to be used more) and is then routed a first direction in the sorting module C and held in a storage bin for “fresh” tennis balls. Likewise, if the internal pressure of the tennis ball 30 is measured below a pre-defined threshold, then the tennis ball 30 is considered to be “dead” and therefore no longer useable, and is then routed a second direction in the sorting module C and held in a storage bin for “dead” tennis balls.

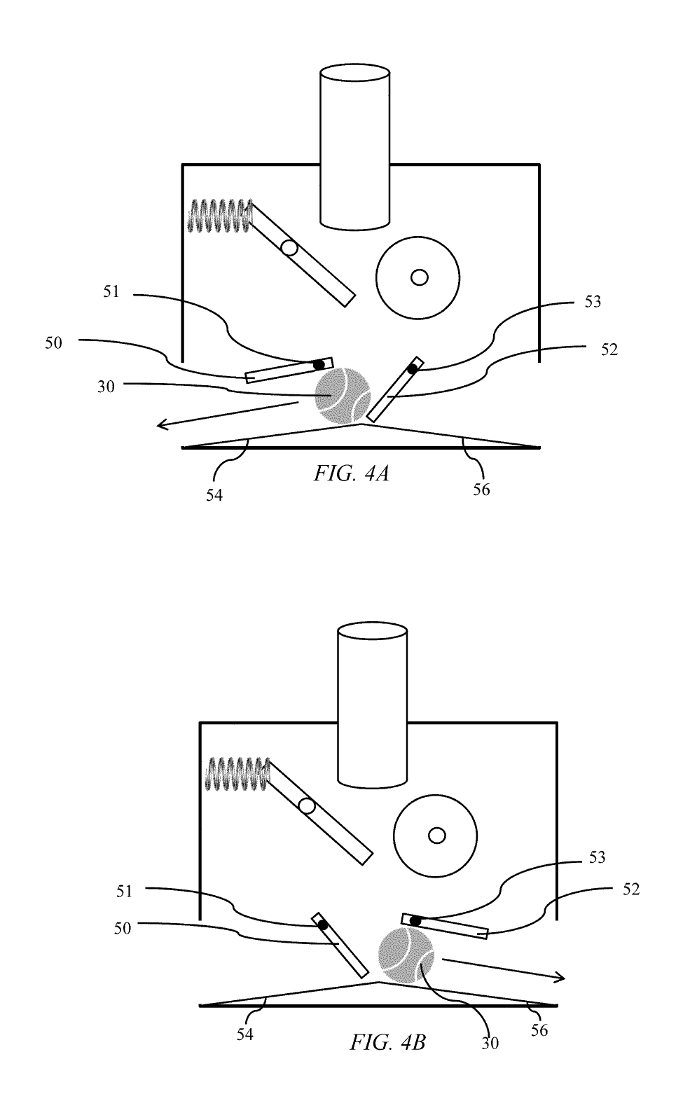

FIGS. 4A and 4B illustrate the sorting module C routing tennis balls in the first or second directions, respectively. Specifically, the sorting module C may have a pair of sorting paddles 50, 52 that may rotate on axes 51, 53, respectively. Viewing FIGS. 4A and 4B, rotating sorting paddles 50, 52 in a clockwise direction routes the tennis balls toward the left down the ramp 54 (as illustrated in FIG. 4A) and rotating the tennis balls in a counter-clockwise direction routes the tennis balls toward the right down the ramp 56 (as illustrated in FIG. 4B). As the tennis balls are routed either one direction or the other, then may traverse down the ramps 54, 56, respectively, and be collected in bins (not shown).

The control of the movement of the sorting paddles 50, 52 is done via the control system (not shown) that controls the movement of the wheel and measures the deflection of the testing paddle 32. Thus, if a tennis ball is determined to be “fresh”, then the sorting paddles 50, 52 may be rotated to route the tennis balls in the first direction to collect in a bin (not shown) with other like “fresh” tennis balls. Likewise, if a tennis ball is determined to be “dead”, then the sorting paddles 50, 52 may be rotated to route the tennis balls in the second direction to collect in a bin (not shown) with other like “dead” tennis balls.

The apparatus 10 may be programmed so as to operate automatically when a plurality of tennis balls are fed into the funnel element 22, and can further test and sort, serially, the plurality of tennis balls without further interaction by a user. After the testing and sorting, the tennis balls may be sorted into at least two bins. More specifically, it is contemplated that the tennis balls tested herein may be grouped into two or more subsets based on their internal pressures. For example, it may be desired to separate tennis balls into “very fresh”, “fresh” and “dead,” for example, or other subsets as desired. The apparatus 10 may therefore have the ability to route in more than two directions, depending on the number of sorted subsets desired.

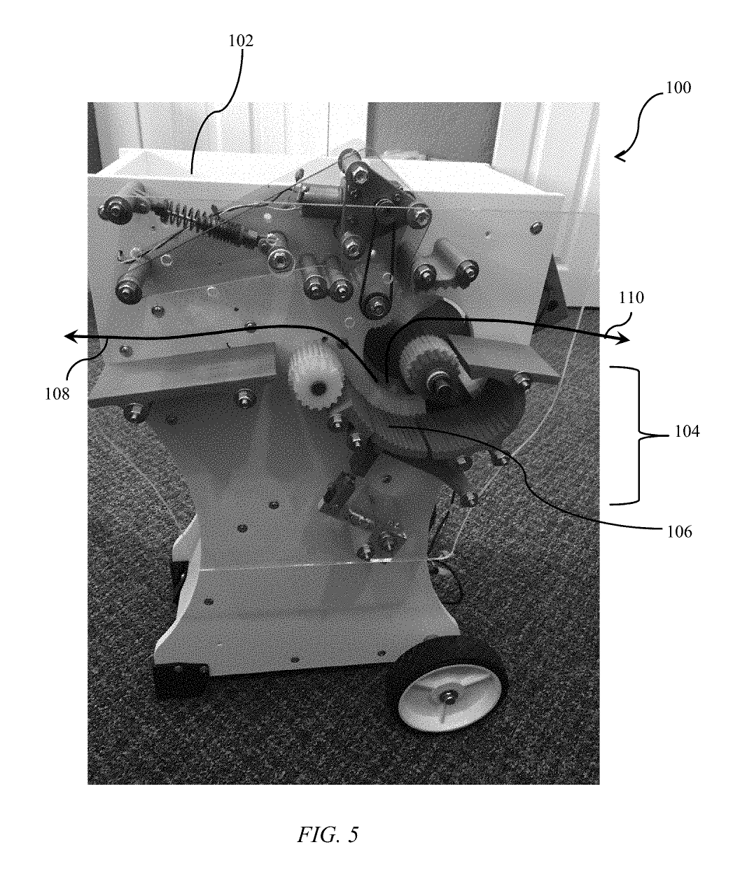

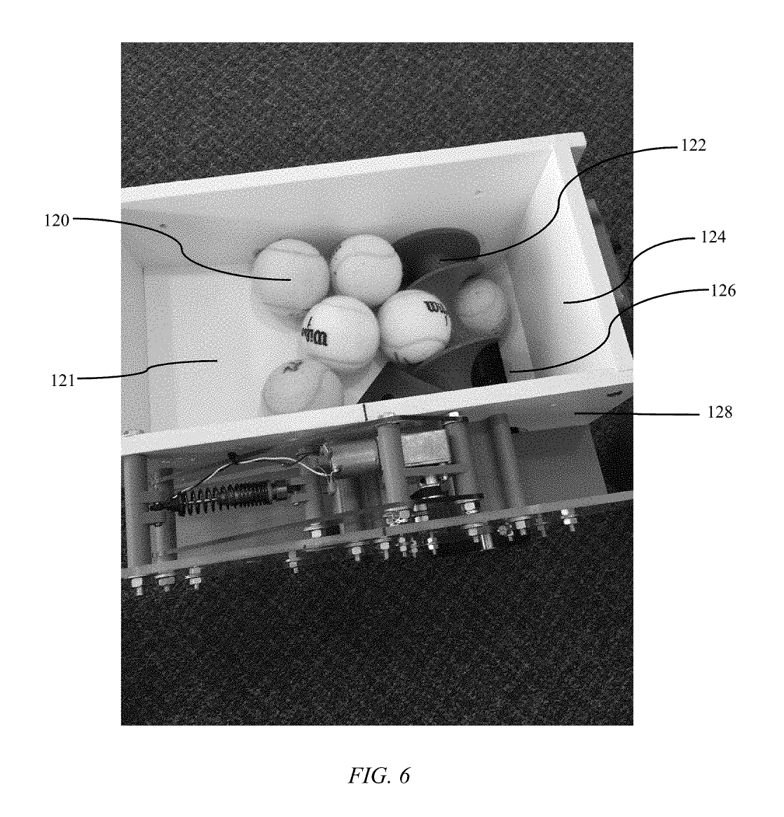

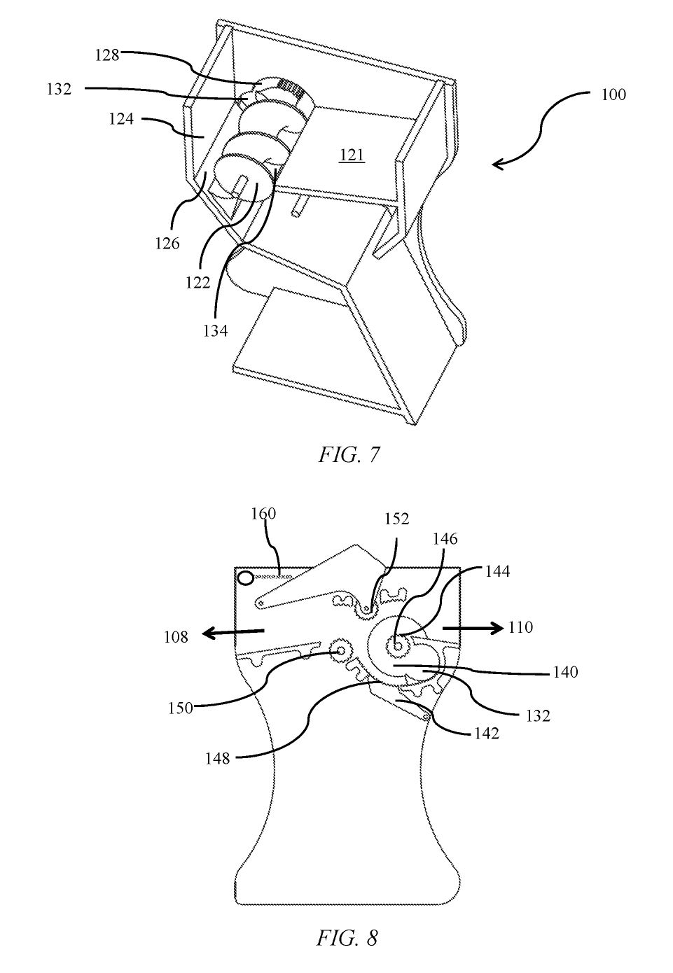

In a preferred embodiment of the present invention, a tennis ball testing and sorting apparatus 100 is illustrated in FIGS. 5-8. The apparatus 100 comprises a tennis ball feeder comprising a hopper 102 into which a plurality of tennis balls may be placed, which is shown and described in further detail in FIGS. 6-7 and below. The apparatus 10 further comprises a testing module 104 for testing the freshness or flatness of individual tennis balls that are sorted therethrough. A tennis ball is fed through the testing module 104 and the internal pressure of the tennis ball is measured via a gauge 106 that determines the internal pressure of the tennis ball. A tennis ball that is deemed to be “flat” (i.e., has an internal pressure below a pre-defined number) is routed through pathway 108 to a waiting bin (not shown). A tennis ball that is deemed to be “fresh” (i.e., has an internal pressure above a pre-defined number) is routed through pathway 110 to a waiting bin to collect the “fresh” tennis balls. Therefore, the “flat” tennis balls are separated from the “fresh” tennis balls, as desired.

FIG. 6 illustrates hopper 102 containing a plurality of tennis balls 120 contained on a ramp 121 therein. The hopper 102 may hold the tennis balls until the apparatus 100 is activated. Once activated, the tennis balls are captured by screw-roller 122 having a thread and pitch size and shape to match the size and shape of the tennis balls, and to move tennis balls therethrough without jamming or shearing of the tennis balls. Specifically, the hopper 102 may have a wall 124 adjacent and parallel to the path of travel of the screw-roller 122 and further having an angled element 126 near a bottom thereof for holding the tennis ball 120 as it traverses toward opening 128. In addition, as illustrated in FIG. 7, a cut-away view of the apparatus 100, a base 130 having a concave top surface may aid in moving the tennis balls toward the opening 128 and, more specifically, to tennis ball opening 132, which may be specifically sized to allow a tennis ball to pass therethrough.

As shown in FIG. 7, openings 134 adjacent and below the screw-roller 122 may allow smaller items, such as smaller balls or other unwanted debris, to fall therethrough without interfering with the screw-roller 122 and the apparatus 100 in general.

Now referring to FIG. 8, a side-view of apparatus 100 is illustrated showing tennis ball opening 132 through which a tennis ball may be fed via the screw-roller 122, as described above. The tennis ball, once fed through tennis ball opening 132, may travel along path 140, toward scale 142 via roller 144. Roller 144 may have teeth or other gripping element that allows the tennis ball to roll or otherwise move along path 140 toward scale 142. Roller 144 has an axis 146 that extends from screw-roller 122 and therefore preferably turns at the same speed as the screw-roller 122. Generally, the screw-roller 122 feeds one tennis ball for every revolution of the screw-roller within the hopper 102, but also feeds one tennis ball for every revolution along path 140 because the roller 144 turns at the same speed.

As the roller 144 moves the tennis ball, the tennis ball rolls over gauge 142, disposed beneath surface 148 of the path 140. The gauge 142 may measure the internal pressure of the tennis ball rolling over the surface 148 by pushing the surface 148 against the tennis ball, thereby applying a pressure to the tennis ball, and measuring the resistance that the tennis ball has against the pressure as the tennis ball is disposed between the surface 148 and the roller 144. The gauge 142 may thus be calibrated to provide a reading corresponding to a defined scale of “freshness” or “flatness”. If the tennis ball measures “fresh” according to the scale defined, the tennis ball may be routed along path 110. Likewise, if the tennis ball measures “flat” according to the scale defined, the tennis ball may be routed along path 108.

The gauge 142 may have a micro-controller associated therewith that takes an average of the internal pressure measurements as the tennis ball rolls over surface 148, discarding certain measurements as needed, such as those measurements taken when the tennis ball rolls onto or off of the surface 148, or when the tennis ball measures the internal pressure where a seam of the tennis ball interacts with the surface 148 and/or the roller 144. These conditions may not represent an accurate internal pressure of a tennis ball and are preferably discarded from the measurements. The average, preferably having the certain inaccurate measurements removed, may thus provide an accurate measurement of the relative internal pressure of the tennis ball, and whether the tennis ball is “fresh” or “flat” as described herein.

Whether a tennis ball is deemed “fresh” or “flat” may be set by a user thereof, who may define the cut-off at which the tennis ball is deemed “fresh” or “flat”. Programming controls (not shown) are thus available to a user to provide such input therein.

As roller 144 turns and moves the tennis ball from the gauge 142 and off the surface 148, a second roller 150 may aid the tennis ball and may move in a counter-clockwise direction, thereby directing the tennis ball along path 140. The second roller 150 may also have teeth, or other gripping element, and may be passive or actively driven by a motor, as needed.

Reversible roller 152 may be provided to move the tennis ball onto path 108 or path 110, depending on whether the tennis ball is deemed “flat” or “fresh”, respectively. Reversible roller 152 may also have teeth or other gripping element, and may change turning directions between a clockwise direction and a counterclockwise direction. Specifically, if the tennis ball is deemed “flat”, the reversible roller 152 may turn in the clockwise direction, thereby pushing the tennis ball toward path 108, where the tennis ball may travel and be collected with other tennis balls deemed “flat”. Likewise, if the tennis ball is deemed “fresh”, the reversible roller 152 may turn in the counterclockwise direction, thereby pushing the tennis ball toward path 110, where the tennis ball may travel and be collected with other tennis balls deemed “fresh”.

The roller 152 may have a control motor associated therewith that may change the turning direction of the roller 152 as needed. In addition, the roller 152 may be biased downwardly via a spring 160 or other biasing mechanism so that the roller 152 has sufficient gripping contact with the tennis ball traveling therethrough, and accurately routes the tennis ball toward the “flat” path 108 or the “fresh” path 110. Collection bins (not shown) may be at the ends of paths 108, 110 to collect the “flat” or “fresh” balls that are routed thereon.

Thus, a plurality of tennis balls may be routed from the hopper 122, through tennis ball opening 132 onto path 140, where the tennis ball's internal pressure is measured via gauge 142. Whether the tennis ball is deemed “flat” or “fresh” may be determined by preset and pre-programmed conditions that are set by a user thereof, whereupon the tennis ball is routed to the “flat” path 108 or the “fresh” path 110, where the tennis balls are collected.

Moreover, it should be noted that while two paths are defined herein, the present invention may have three or more paths depending on whether a user wishes to divide the tennis balls into three or more different categories based on their internal pressures. In a method of the present invention, a user may further separate the “flat” and/or “fresh” tennis balls into additional categories based on relative degrees of “flatness” or “freshness” by feeding the “flat” or the “fresh” collection of tennis balls into the apparatus 100 and resetting the cut-off that defines a flat tennis ball from a fresh tennis ball.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. A ball sorting apparatus comprising:
a feeder for holding a plurality of balls and feeding each of the plurality of balls to a testing unit, wherein the testing unit tests the internal pressure of each as each ball is fed thereinto; and
a separation unit, wherein the separation unit routes the ball into one of two or more paths based on its internal pressure.

2. The ball sorting apparatus of claim 1 wherein the feeder comprises a hopper, wherein the hopper holds the large number of balls.

3. The ball sorting apparatus of claim 1 wherein the feeder comprises a screw, wherein the screw has a thread and pitch, wherein the thread and pitch of the screw are sized to hold the ball therein.

4. The ball sorting apparatus of claim 1 wherein the ball is a tennis ball.

5. The ball sorting apparatus of claim 1 wherein the testing unit comprises a first surface and a second surface and a gauge interconnected with the first surface, wherein when the ball is positioned between the first surface and the second surface, the gauge pushes the first surface against the ball thereby applying a pressure to the ball and further wherein the gauge measures a resistance of the ball in response to the pressure on the ball, wherein the resistance of the ball corresponds to the ball's internal pressure.

6. The ball sorting apparatus of claim 1 wherein the gauge takes a plurality of readings of the ball.

7. The ball sorting apparatus of claim 1 further comprising:
an opening on a side of the feeder aligned with the screw, wherein the ball is fed through the opening by the screw onto a ball path that leads to the testing unit.

8. The ball sorting apparatus of claim 7 wherein the ball path comprises a first surface and a second surface, wherein the second surface comprises a first roller having a gripping element and the ball moves along the first surface due to turning of the roller.

9. The ball sorting apparatus of claim 8 wherein the first roller is interconnected to the screw and turns at the same speed as the screw.

10. The ball sorting apparatus of claim 1 wherein the separation unit comprises a reversible roller and a first path and a second path, wherein when the ball is tested by the testing unit and has a measured internal pressure below a pre-defined internal pressure, the reversible roller turns a first direction and routes the ball onto the first path, and further when the ball has a measured internal pressure above a pre-defined internal pressure, the reversible roller turns a second direction and routes the ball onto the second path.

11. The ball sorting apparatus of claim 10 wherein the first path leads to a first collection bin, and the second path leads to a second collection bin.

12. A method of testing and sorting balls comprising an internal pressure comprising the steps of:
providing a ball sorting apparatus comprising a feeder for holding a plurality of balls and feeding each of the plurality of balls to a testing unit, wherein the testing unit tests the internal pressure of each ball as each ball is fed thereinto, and a separation unit, wherein the separation unit routes each ball into one of two or more paths based on the internal pressure of each ball; and
feeding a plurality of balls into the feeder, wherein the feeder feeds a first ball into the testing unit wherein the testing unit tests the internal pressure of the first ball, and further wherein the separation unit feeds the first ball into the one of two or more paths based on the internal pressure of the first ball.

13. The method of claim 12 wherein the feeder comprises a hopper, wherein the hopper holds the large number of balls.

14. The method of claim 12 wherein the feeder comprises a screw, wherein the screw has a thread and pitch, wherein the thread and pitch of the screw are sized to hold the ball therein, and further wherein the screw moves the first ball out of the feeder.

15. The method of claim 12 wherein the first ball is a tennis ball.

16. The method of claim 1 wherein the testing unit comprises a first surface and a second surface and a gauge interconnected with the first surface and further comprising the steps of:
feeding the first ball between the first surface and the second surface wherein when the first ball is positioned between the first surface and the second surface, the gauge pushes the first surface against the first ball thereby applying a pressure to the first ball;
measuring, via the gauge, a resistance of the ball in response to the pressure on the ball wherein the resistance of the ball corresponds to the ball's internal pressure.

17. The method of claim 16 further comprising the step of:
taking a plurality of readings of the first ball via the gauge.

18. The method of claim 12 wherein a side of the feeder comprises an opening aligned with the screw, and further comprising the step of:
feeding the first ball through the opening via the screw, onto a ball path that leads to the testing unit.

19. The method of claim 18 wherein the ball path comprises a first surface and a second surface, wherein the second surface comprises a first roller interconnected with the screw and having a gripping element, the method further comprising the steps of:
turning the first roller; and
moving the first ball along the first surface due to turning of the roller.

20. The method of claim 12 wherein the separation unit comprises a reversible roller and a first path and a second path, and further comprising the step of:
when after testing the internal pressure of the first ball and the first ball has a measured internal pressure below a pre-defined internal pressure, routing the first ball onto the first path by turning the reversible roller the first direction or routing the first ball onto the second path by turning the reversible roller in a second direction.
